(19) United States
(12) Patent Application Publication
(10) Pub. No.: US 2017/0372436 A1
(43) Pub. Date: Dec. 28, 2017

(54) MATCHING REQUESTS-FOR-PROPOSALS WITH SERVICE PROVIDERS

(71) Applicant: Linkedln Corporation, Mountain View, CA (US)

(72) Inventors: Onkar Anant Dalal, Santa Clara, CA (US); Vaibhav Goel, Mountain View, CA (US); Ajita Thomas, Sunnyvale, CA (US); Shuo Miao, Sunnyvale, CA (US); Yi Zhang, Sunnyvale, CA (US)

(21) Appl. No.: 15/192,492

(22) Filed: Jun. 24, 2016

(51) Int. Cl. G06Q 50/00; G06N 5/02; G06F 17/30

(52) U.S. Cl. CPC G06Q 50/01; G06F 17/3053; G06N 5/022

(57) ABSTRACT

A system, a machine-readable storage medium storing instructions, and a computer-implemented method are described herein for a Prediction Engine for identifying service provider account(s) in a social network service based in part on request data representative of a request, from a target consumer account in the social network service, for a service. The Prediction Engine assembles, according to encoded rules of a prediction model, feature vector data for each identified service provider account, wherein each encoded rule of the prediction model comprises a pre-defined featurer(s) associated with a learned coefficient representing an importance of the respective pre-defined feature. The Prediction Engine generates, based on the feature vector data and the encoded rules of the prediction model, prediction output for each identified service provider account. The prediction output indicative of a likelihood that a respective service provider account will perform an action related to the requested service.

### TECHNICAL FIELD

The present disclosure generally relates to data processing systems. More specifically, the present disclosure relates to methods, systems and computer program products for predicting actions of one or more member accounts.

### BACKGROUND

A social networking service is a computer- or web-based application that enables users to establish links or connections with persons for the purpose of sharing information with one another. Some social networking services aim to enable friends and family to communicate with one another, while others are specifically directed to business users with a goal of enabling the sharing of business information. For purposes of the present disclosure, the terms “social network,” “social network service” and “social networking service” are used in a broad sense and are meant to encompass services aimed at connecting friends and family (often referred to simply as “social networks”), as well as services that are specifically directed to enabling business people to connect and share business information (also commonly referred to as “social networks” but sometimes referred to as “business networks”).

With many social networking services, members are prompted to provide a variety of personal information, which may be displayed in a member's personal web page. Such information is commonly referred to as personal profile information, or simply “profile information”, and when shown collectively, it is commonly referred to as a member's profile. For example, with some of the many social networking services in use today, the personal information that is commonly requested and displayed includes a member's age, gender, interests, contact information, home town, address, the name of the member's spouse and/or family members, and so forth. With certain social networking services, such as some business networking services, a member's personal information may include information commonly included in a professional resume or curriculum vitae, such as information about a person's education, employment history, skills, professional organizations, and so on. With some social networking services, a member's profile may be viewable to the public by default, or alternatively, the member may specify that only some portion of the profile is to be public by default. Accordingly, many social networking services serve as a sort of directory of people to be searched and browsed.

### DESCRIPTION OF THE DRAWINGS

Some embodiments are illustrated by way of example and not limitation in the figures of the accompanying drawings in which:

FIG. 1 is a block diagram showing the functional components of a social networking service, according to various embodiments;

FIG. 2 is a block diagram of an example system, according to various embodiments;

FIG. 3 is a flowchart illustrating an example method, according to various embodiments;

FIG. 4 illustrates a data flow diagram of a Prediction Engine assembling a feature vector of a service provider account, according to various embodiments;

FIG. 5 is a block diagram showing example components of a Prediction Engine, according to various embodiments;

FIG. 6 is a diagrammatic representation of a machine in the example form of a computer system within which a set of instructions, for causing the machine to perform any one or more of the methodologies discussed herein, may be executed according to various embodiments.

### DETAILED DESCRIPTION

The present disclosure describes methods and systems for predicting a likelihood a provider service account(s) will perform an action in response to a request from a target consumer account. In the following description, for purposes of explanation, numerous specific details are set forth in order to provide a thorough understanding of the various aspects of different embodiments described herein. It will be evident, however, to one skilled in the art, that the embodiments described herein may be practiced without all of the specific details.

A system, a machine-readable storage medium storing instructions, and a computer-implemented method are described herein for a Prediction Engine for identifying service provider account(s) in a social network service based in part on request data representative of a request for a service. The request for a service is received from a target consumer account in the social network service. The Prediction Engine assembles, according to encoded rules of a prediction model, feature vector data for each identified service provider account. Each encoded rule of the prediction model comprises a pre-defined feature(s) associated with a learned coefficient representing an importance of the respective pre-defined feature. The Prediction Engine generates, based on the feature vector data and the encoded rules of the prediction model, prediction output for each identified service provider account. The prediction output is indicative of a likelihood that a respective service provider account will perform an action related to the requested service.

According to various exemplary embodiments, the Prediction Engine receives a request-for-proposal of services from a target consumer account. The request indicates a type of service selected by the target consumer account and one or more specialties and skills that are required to complete the requested service. The Prediction Engine uses attributes selected by each service provider account to identify service provider accounts qualified for the requested service. In addition, the Prediction Engine builds, trains and utilizes a prediction model to further infer which of the service provider accounts are best qualified for the requested service by predicting a likelihood of each service provider account submitting a proposal in response to the requested service.

The Prediction Engine ranks the identified service provider accounts according to their predicted likelihood of proposal submission. The Prediction Engine sends a notification of the requested service to a first portion of the ranked service provider accounts. After a given period of time has elapsed, if a pre-defined threshold number of proposals are not sent from the notified service provider accounts, the Prediction Engine sends a notification of the requested service to a second portion of the ranked service provider accounts. After another given period of time has elapsed, if the pre-defined threshold number of proposals are not sent from the notified service provider accounts, the Prediction Engine sends a notification of the requested service to a third portion of the ranked service provider accounts.

The Prediction Engine thereby uilitzes the prediction model to infer which service provider accounts are not only the most qualified to provide the requested service, but most likely to actually submit a proposal to provide the requested service to the target consumer account. The prediction model includes pre-defined features which are based on raw data and one or more attributes of the requested service, the target consumer account and/or a service provider account(s). A pre-defined feature is included in the prediction model based on the pre-defined feature being identified—during a machine learning model training process —as being germane in predicting a service provider account's actions. A feature is based on raw data, attributes and actions of member accounts with respect to requests for services that are learned by the prediction model as being germane in identifying which of the service provider accounts are best qualified for a given requested service.

In various embodiments, the prediction model is a model built, trained and implemented according to one of various known prediction modeling techniques. Training data is used to train the prediction model. The training process identifies the features of the prediction model. To build and train the prediction model, the Prediction Engine may perform a prediction modeling process based on a statistics-based machine learning model such as a logistic regression model. Other prediction modeling techniques may include other machine learning models such as a Naïve Bayes model, a support vector machines (SVM) model, a decision trees model, and a neural network model, all of which are understood by those skilled in the art.

According to various exemplary embodiments, the Prediction Engine may be executed for the purposes of both off-line training (for generating, training, and refining the prediction model) and online inferences (for predicting a likelihood that a respective service provider account will perform an action related to the requested service).

It is understood that various embodiments further include encoded instructions that comprise operations to generate a user interface(s) and various user interface elements. The user interface and the various user interface elements can be representative of any of the operations, data, models, prediction output, features, accounts, notifications, proposal requests and submitted proposals, as described herein. In addition, the user interface and various user interface elements are generated by the Prediction Engine for display on a computing device, a server computing device, a mobile computing device, etc.

According to various exemplary embodiments, the Prediction Engine may be used for the purposes of both off-line training (for generating, training, and refining the job applicant quality model and online inferences (for predicting whether a given job candidate account is relevant to a given job posting). As described in various embodiments, the Prediction Engine may be a configuration-driven system for building, training, and deploying prediction models for predicting service provider account actions and activity. In particular, the operation of the Prediction Engine is completely configurable and customizable by a user through a user-supplied configuration file such as a JavaScript Object Notation (JSON), eXtensible Markup Language (XML) file, etc.

For example, each module in the Prediction Engine may have text associated with it in a configuration file(s) that describes how the module is configured, the inputs to the module, the operations to be performed by the module on the inputs, the outputs from the module, and so on. Accordingly, the user may rearrange the way these modules are connected together as well as the rules that the various modules use to perform various operations. Thus, whereas conventional prediction modeling is often performed in a fairly ad hoc and code driven manner, the modules of the Prediction Engine may be configured in a modular and reusable fashion, to enable more efficient prediction modeling.

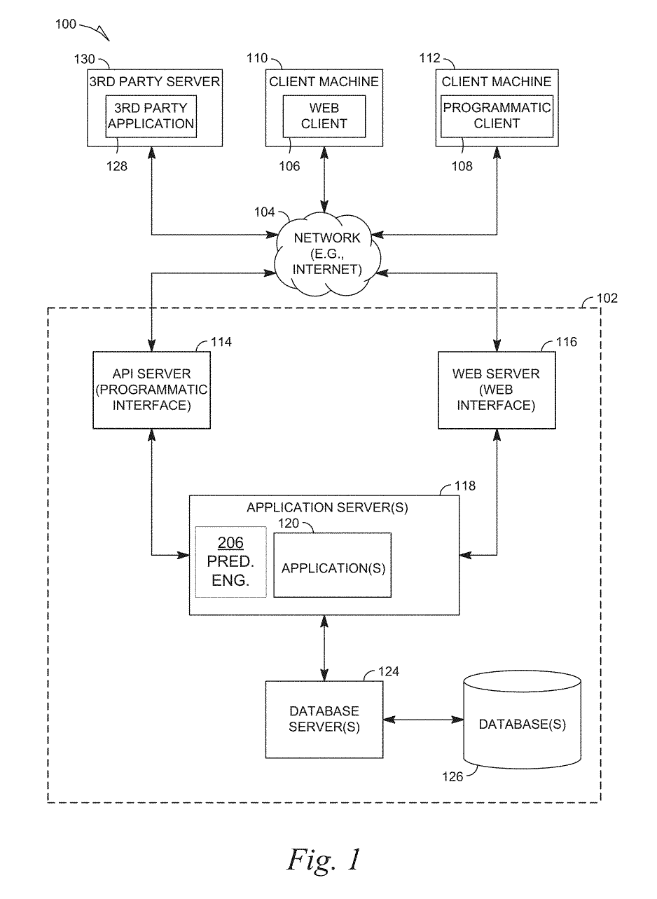

Turning now to FIG. 1, FIG. 1 is a block diagram illustrating a client-server system, in accordance with an example embodiment. A networked system 102 provides server-side functionality via a network 104 (e.g., the Internet or Wide Area Network (WAN)) to one or more clients. FIG. 1 illustrates, for example, a web client 106 (e.g., a browser) and a programmatic client 108 executing on respective client machines 110 and 112.

An Application Program Interface (API) server 114 and a web server 116 are coupled to, and provide programmatic and web interfaces respectively to, one or more application servers 118. The application servers 118 host one or more applications 120. The application servers 118 are, in turn, shown to be coupled to one or more database servers 124 that facilitate access to one or more databases 126. While the applications 120 are shown in FIG. 1 to form part of the networked system 102, it will be appreciated that, in alternative embodiments, the applications 120 may form part of a service that is separate and distinct from the networked system 102. In some embodiments, the application servers 118 include Prediction Engine 206. However, it is understood that the Prediction Engine 206 can be implemented by any component(s) of system 102. It is also understood a portion of the Prediction Engine 206 can be implemented by any component(s) of system 102.

Further, while the system 100 shown in FIG. 1 employs a client-server architecture, the present disclosure is of course not limited to such an architecture, and could equally well find application in a distributed, or peer-to-peer, architecture system, for example. The various applications 120 could also be implemented as standalone software programs, which do not necessarily have networking capabilities.

The web client 106 accesses the various applications 120 via the web interface supported by the web server 116. Similarly, the programmatic client 108 accesses the various services and functions provided by the applications 120 via the programmatic interface provided by the API server 114.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more functions that are supported by the relevant applications of the networked system 102. In some embodiments, the networked system 102 may comprise functional components of a professional social network.

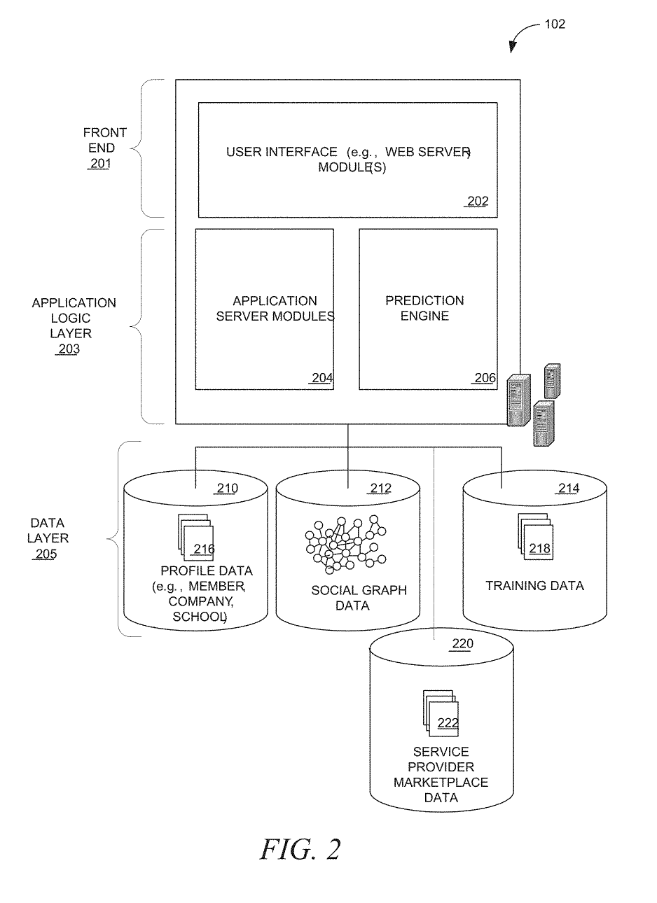

FIG. 2 is a block diagram showing functional components of a professional social network within the networked system 102, in accordance with an example embodiment.

As shown in FIG. 2, the professional social network may be based on a three-tiered architecture, consisting of a front-end layer 201, an application logic layer 203, and a data layer 205. In some embodiments, the modules, systems, and/or Systems shown in FIG. 2 represent a set of executable software instructions and the corresponding hardware (e.g., memory and processor) for executing the instructions. To avoid obscuring the inventive subject matter with unnecessary detail, various functional modules and systems that are not germane to conveying an understanding of the inventive subject matter have been omitted from FIG. 2. However, one skilled in the art will readily recognize that various additional functional modules and systems may be used with a professional social network, such as that illustrated in FIG. 2, to facilitate additional functionality that is not specifically described herein. Furthermore, the various functional modules and systems depicted in FIG. 2 may reside on a single server computer, or may be distributed across several server computers in various arrangements. Moreover, although a professional social network is depicted in FIG. 2 as a three-tiered architecture, the inventive subject matter is by no means limited to such architecture. It is contemplated that other types of architectures are within the scope of the present disclosure.

As shown in FIG. 2, in some embodiments, the front-end layer 201 comprises a user interface module (e.g., a web server) 202, which receives requests and inputs from various client-computing devices, and communicates appropriate responses to the requesting client devices. For example, the user interface module(s) 202 may receive requests in the form of Hypertext Transport Protocol (HTTP) requests, or other web-based, application programming interface (API) requests.

In some embodiments, the application logic layer 203 includes various application server modules 204, which, in conjunction with the user interface module(s) 202, generates various user interfaces (e.g., web pages) with data retrieved from various data sources in the data layer 205. In some embodiments, individual application server modules 204 are used to implement the functionality associated with various services and features of the professional social network. For instance, the ability of an organization to establish a presence in a social graph of the social network service, including the ability to establish a customized web page on behalf of an organization, and to publish messages or status updates on behalf of an organization, may be services implemented in independent application server modules 204. Similarly, a variety of other applications or services that are made available to members of the social network service may be embodied in their own application server modules 204.

As shown in FIG. 2, the data layer 205 may include several databases, such as a database 210 for storing profile data 216, including both member profile attribute data as well as profile attribute data for various organizations. Consistent with some embodiments, when a person initially registers to become a member of the professional social network, the person will be prompted to provide some profile attribute data such as, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information may be stored, for example, in the database 210. Similarly, when a representative of an organization initially registers the organization with the professional social network the representative may be prompted to provide certain information about the organization. This information may be stored, for example, in the database 210, or another database (not shown). With some embodiments, the profile data 216 may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or a seniority level within a particular company. With some embodiments, importing or otherwise accessing data from one or more externally hosted data sources may enhance profile data 216 for both members and organizations. For instance, with companies in particular, financial data may be imported from one or more external data sources, and made part of a company's profile.

The profile data 216 may also include information regarding settings for members of the professional social network. These settings may comprise various categories, including, but not limited to, privacy and communications. Each category may have its own set of settings that a member may control.

Once registered, a member may invite other members, or be invited by other members, to connect via the professional social network. A “connection” may require a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member follows another, the member who is following may receive status updates or other messages published by the member being followed, or relating to various activities undertaken by the member being followed. Similarly, when a member follows an organization, the member becomes allowed to receive messages or status updates published on behalf of the organization. For instance, messages or status updates published on behalf of an organization that a member is following will appear in the member's personalized data feed or content stream. In any case, the various associations and relationships that the members establish with other members, or with other entities and objects, may be stored and maintained as social graph data within a social graph database 212.

The professional social network may provide a broad range of other applications and services that allow members the opportunity to share and receive information, often customized to the interests of the member. For example, with some embodiments, the professional social network may include a photo sharing application that allows members to upload and share photos with other members. With some embodiments, members may be able to self-organize into groups, or interest groups, organized around a subject matter or topic of interest. With some embodiments, the professional social network may host various job listings providing details of job openings with various organizations.

As members interact with the various applications, services and content made available via the professional social network, the members' behaviour (e.g., content viewed, links or member-interest buttons selected, etc.) may be monitored and information 218 concerning the member's activities and behaviour may be stored, for example, as indicated in FIG. 2, by the database 214. This information 218 can be training data that comprises in part professional social network activity of member accounts with respect to one or more requests for services. Such professional social network activity includes a member account requesting a proposal for a type of service and various member accounts submitting service proposals in response based on the requested service. The data layer 205 further includes a service provider marketplace data repository' 220, which includes data regarding various types of services offered by member accounts, skills and specialties of member accounts as well as data for processing transactions based on a member account accepting a proposal for services.

In some embodiments, the professional social network provides an application programming interface (API) module via which third-party applications can access various services and data provided by the professional social network. For example, using an API, a third-party application may provide a user interface and logic that enables an authorized representative of an organization to publish messages from a third-party application to a content hosting platform of the professional social network that facilitates presentation of activity or content streams maintained and presented by the professional social network. Such third-party applications may he browser-based applications, or may be operating system-specific. In particular, some third-party applications may reside and execute on one or more mobile devices (e.g., a smartphone, or tablet computing devices) having a mobile operating system.

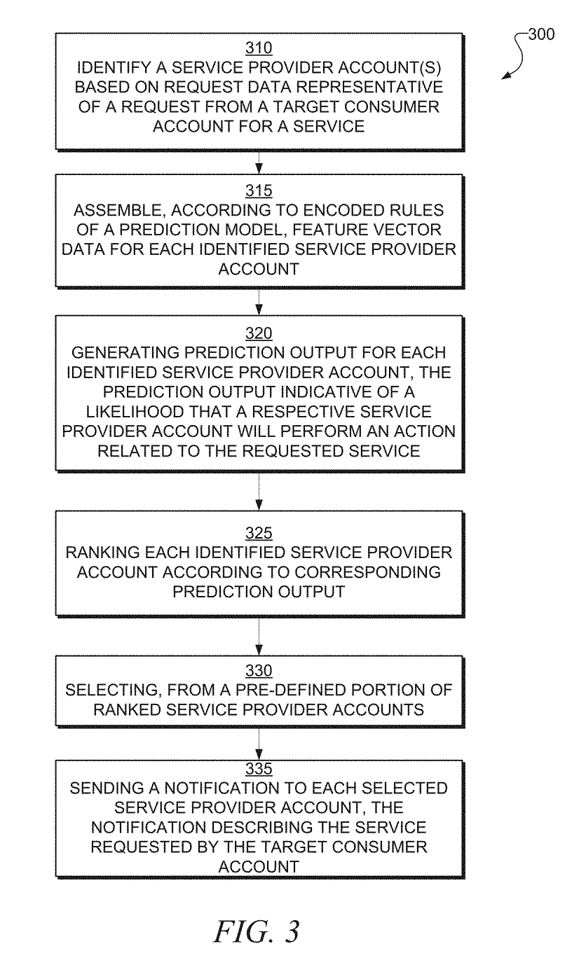

The data in the data layer 205 may be accessed, used, and adjusted by the Prediction Engine 206 as will be described in more detail below in conjunction with FIGS. 3-8. Although the Prediction Engine 206 is referred to herein as being used in the context of a professional social network, it is contemplated that it may also be employed in the context of any website or online services, including, but not limited to, content sharing sites (e.g., photo- or video-sharing sites) and any other online services that allow users to have a profile and present themselves or content to other users. Additionally, although features of the present disclosure are referred to herein as being used or presented in the context of a web page, it is contemplated that any user interface view (e.g., a user interface on a mobile device or on desktop software) is within the scope of the present disclosure. It is understood that the Prediction Engine 206 can be implemented in one or more of the application servers 118.

FIG. 3 is a flowchart illustrating an example method 300, according to various embodiments.

At operation 310, the Prediction Engine 206 identifies a service provider account(s) in a social network service based in part on request data representative of a request, from a target consumer account in the social network service, for a service. The Prediction Engine 206 identifies service provider accounts to provide the target consumer account with a requested service based on explicit service requirements selected by the target consumer account, explicit attributes selected by each service provider account, and inferred attributes of each service provider account.

For example, a target consumer account provides the Prediction Engine 206 with explicit service requirements by accessing a resource (such as a first web page) within the social network service. The first webpage presents a plurality of icons. Each icon represents a selectable service, such as: Accounting, Marketing, Coaching, Insurance, Software Development. The target consumer selects the Software Development icon as the desired service.

Based on the selected desired service, the Prediction Engine 206 presents a listing of selectable skills and selectable specialities of Software Development. The listing of selectable skills and selectable specialties includes: Web Design, Cloud Management, Software Testing, Enterprise Content Management and Application Development. The target consumer account selects Application Development as a desired skill.

Each service provider account includes explicitly selected attributes that describe the service provider account's offered services, skills and specialities. The Prediction Engine 206 identifies service provider accounts with service attributes, skills attributes, specialty attributes that match with the target consumer account's explicitly selected service requirements. In addition to matching based on explicit selections and attributes, the Prediction Engine 206 utilizes features of the prediction model to infer which service provider accounts that match with the target consumer accounts' selected service requirements are most likely to submit a service proposal to the target consumer account's.

At operation 315, the Prediction Engine 206 assembles, according to encoded rules of a prediction model, feature vector data for each identified service provider account. Each encoded rule of the prediction model comprises at least one pre-defined feature associated with a learned coefficient representing an importance of the respective pre-defined feature.

For example, the Prediction Engine 206 accesses feature vector encoding rules describing a vector position for each type of feature. More specifically, the feature vector encoding rules may state that, for example, a feature for a profile account metric is to be stored at a position X1 of a service provider account's feature vector, a geographical distance feature is to be stored a position X2, a recommendations feature is to be stored at a position X3, a social graph feature is to be stored at position X4, a number of notifications of requests is to be stored at position X5, a service provider response rate is to be stored at position X6, a quality metric feature is to be stored at position X7, a consumer response rate feature is to be stored at position X8, a service provider availability feature is to be stored at position X9, and so on. Thus, the resulting feature vector includes various features of a specific service account provider. In addition, the encoding process may involve converting raw data of the service provider account into an internal representation (e.g., into a numerical value) for insertion into the feature vector, based on the feature vector encoding rules.

At operation 320, the Prediction Engine 206 generates, based on the feature vector data and the encoded rules of the prediction model, prediction output for each identified service provider account, the prediction output indicative of a likelihood that a respective service provider account will perform an action related to the requested service.

According to various embodiments, the prediction model is a logistic regression model. As understood by those skilled in the art, logistic regression is an example of a statistics-based machine learning technique that uses a logistic function. The logistic function is based on a variable, referred to as a logit. The logit is defined in terms of a set of regression coefficients of corresponding independent predictor variables. Logistic regression can be used to predict the probability of occurrence of an event (or action) given a set of independent/predictor variables.

The independent/predictor variables of the prediction model are the attributes represented by the assembled feature vectors based on the types of features described throughout. The regression coefficients may be estimated using maximum likelihood or learned through a supervised learning technique from data collected in logged data or calculated from log data describing various requested services and various service provider accounts. Accordingly, once the appropriate regression coefficients (e.g., A) are determined, the features are inserted into various data locations in order to assemble a feature vector. The feature vector may be input to the prediction model in order to calculate a probability that an action X occurs (where the action X may be, for example, whether a service provider account submits a service proposal in response to a target consumer account's service request). Stated differently, an assembled feature vector for a respective service provider account is based on various types of features of the respective service provider account and the corresponding regression feature coefficients. Features for the respective service provider account are based on raw data and the respective service provider's attributes.

The Prediction Engine 206 inputs the assembled feature vector associated with a service provider account into the prediction model to calculate prediction output that represents a probability that the service provider account will submit a service proposal for the target consumer account's requested service. As a result, the Prediction Engine 206 identifies service provider accounts with explicit attributes that match the target consumer account's explicit service requirements and calculates the prediction output in order to infer how likely each identified service provider account will take an action in response to the service requested by the target consumer account.

At operation 325, the Prediction Engine 206 ranks each identified service provider account according to corresponding prediction output. For example, the Prediction Engine 206 ranks each service provider account according to their respective prediction output from a highest prediction output value to a lowest prediction output value.

At operation 330, the Prediction Engine 206 selects, from a pre-defined portion of ranked service provider accounts. For example, a pre-defined portion can be, for example, a grouping of three ranked service provider accounts, a grouping of five ranked service provider accounts, or a certain percentage of ranked service provider accounts (i.e. 3%, 5%, 10%, etc.) If the pre-defined portion is a grouping of three ranked service provider accounts, the Prediction Engine 206 successively selects three ranked service provider accounts at a time. The Prediction Engine 206 initially selects the top three (1, 2, 3) ranked service provider accounts.

At operation 335, the Prediction Engine 206 sends a notification to each selected service provider account. Each notification describes the service requested by the target consumer account. Continuing with the example based on the pre-defined portion being a grouping of three (or some other predetermined number of) ranked service provider accounts, the Prediction Engine 206 initially sends a notification that describes the requested service to each of the top three ranked service provider accounts. Upon sending the notifications, a waiting period is triggered by the Prediction Engine 206 to give the service provider accounts time to prepare and submit a service proposal for the target consumer account. Upon termination of the waiting period, the Prediction Engine 206 determines whether a threshold number of proposals have been sent to the target consumer account.

If the threshold number of proposals is satisfied, no more notifications are sent by the Prediction Engine 206. However, if the threshold number of proposals is not satisfied, the Prediction Engine 206 returns to operation 330 and selects the next three (4, 5, 6) (or other predetermined number of) ranked service provider accounts. After selecting the next three ranked service provider accounts, the Prediction Engine 206 returns to operation 335 and sends notifications to the next three ranked service provider accounts. The Prediction Engine 206 continues a loop between operation 330 and operation 335 to successively select groupings of ranked service provider accounts and send notifications until the threshold number of proposals have been sent to the target consumer account.

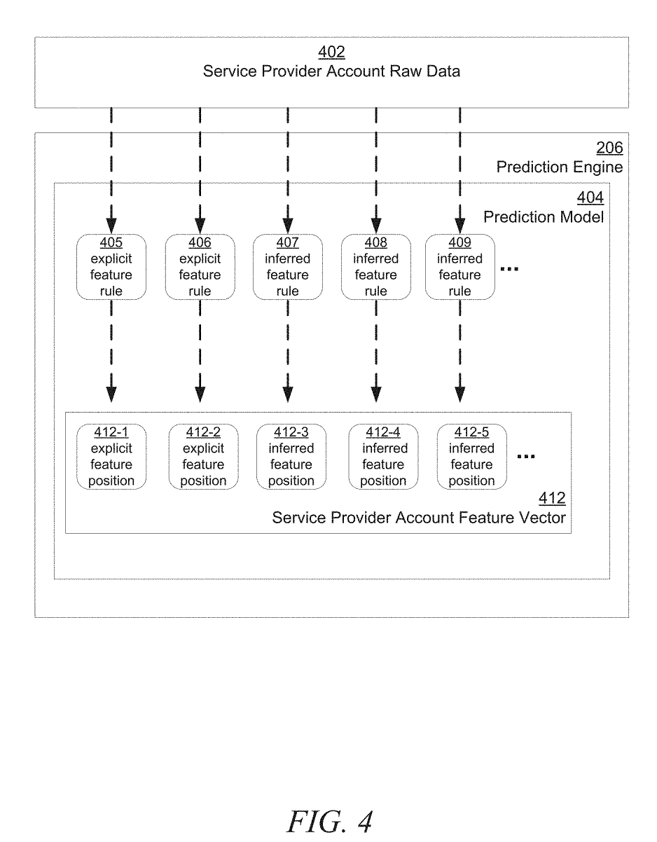

FIG. 4 illustrates a data flow diagram of a Prediction Engine 206 assembling a feature vector of a service provider account, according to various embodiments.

The prediction model 404 of the Prediction Engine 206 includes various explicit feature rules 405, 406. The Prediction Engine 206 accesses a service provider account's raw data 402 in order to assemble a feature vector 412. The Prediction Engine 206 captures attributes explicitly selected by the service provider account (such as type of services offered, skills, specialties) and encodes the explicit attributes according to the explicit feature rules 405, 406. The explicit feature rules 405, 406 can include rules for converting raw data into an internal representation for insertion into an explicit feature position 412-1, 412-2 of a feature vector 412. For example, string values are converted to a numeric value. In addition, the prediction model 404 includes mapping rules to map the explicit attributes to pre-defined values.

The prediction model 404 further includes encoded interred feature rules 407, 408, 409 . . . which define a type of inferred feature and rules of converting raw data for the inferred feature to an internal representation for insertion in a corresponding inferred feature position 412-2, 412-4, 412-5 . . . The inferred feature rules 407, 408, 409 . . . also include rules for raw data conversion or mapping rules that map to a pre-defined value.

A first inferred feature can be based on a profile account metric of the service provider account. The profile account metric represents a completeness of one or more sections of a profile of the service provider account. A second inferred feature is based on a geographical distance between the target consumer account and a service provider account. For example, both profiles of the target consumer account and the service provide account indicate a current city, current country or current geographical region. The second inferred feature is based on a distance metric between the target consumer account's and the service provide account's current cities, current countries or current geographical regions.

A third inferred feature is based on recommendations a service account provider has received from various other consumer accounts for whom the service provider account has provided a previous service. The third inferred feature is based on at least one of: a quantity of the recommendations, a quality of recommendations and measure of how recently each recommendation was received. For example, a recommendation can be a represented according to a number of stars selected by a consumer account. The more stars selected, the higher in quality the recommendation. The third inferred feature can be based on a percentage of recommendations that are above or below) a certain number of stars.

A fourth inferred feature is based on a social graph of the target consumer account and the service provider account. The Prediction Engine 206 determines a social network distance based on a number of shared social network connections and a strength of each shared social network connections. Strength of a social network connection is a metric based on a number of social network interactions between accounts within a certain period of time. A social network interaction is one or more of a message, a shared post, a like, a rating, a profile post sent between the accounts.

A fifth inferred feature is based on a number of notifications of requests for services that a service provider account has previously received. If the Prediction Engine 206 has previously identified and ranked a service provider account for previous requests for services from other consumer accounts, the Prediction Engine 206 determines how many notifications have been sent to the service provider account during a time range. If the number of notifications is below a threshold amount, the prediction model 404 indicates a regression coefficient for the fifth inferred feature that will boost the ranking of the service provider account since the low number of notifications may indicate the service provider account is new or hasn't engaged new customers. If the number of notifications is above the threshold amount, the prediction model 404 indicates a different regression coefficient for the fifth inferred feature that will not provide the ranking boost.

A sixth interred feature is based on a response rate of a service account provider. The Prediction Engine 206 stores each time a service account provider sends a service proposal to a consumer account in response to a. notification of a request for proposal. The Prediction Engine 206 further determines response time for a service provider account based on an amount of time between sending the notification to the service account provider and receiving the service account provider's service proposal. The Prediction Engine 206 calculates a response rate as an average of various response times of the service provider account during a pre-defined period of time.

A seventh interred feature is based on a quality metric for a service account's previous service proposals sent to various consumer account. Each service proposal has a various data size for text, images, video, etc. The quality metric can be based in part on the average size of the service account's previous service proposals sent within a pre-defined period of time. The quality metric can also be based on differences between previous service proposals prepared by the service provider account. The Prediction Engine 206 compares size, keywords, text, and formatting of previous service proposal to calculate an average variance in the size, keywords, text and formatting. If the average variance satisfies a variance threshold, this indicates the provider service account invested effort in customizing each previous service proposal instead of using a form template. If the average variance does not satisfy the variance threshold, the seventh inferred feature will not be included to generate prediction output for the corresponding service account provider.

An eighth inferred feature is based on a consumer response rate. The Prediction Engine 206 tracks and stores each time a consumer account responds to a. service proposal sent from a service provider account. The Prediction Engine 206 calculates a total amount of responses from consumer accounts or calculates percentage of service proposals that prompted responses from consumer accounts.

A ninth inferred feature is based on an availability of a service provider account. The Prediction Engine 206 tracks and stores previous notifications sent to each service provider from other consumer accounts. If the Prediction Engine 206 determines that a service provider account has received a threshold number of notifications within a period of time. It is understood that, in some embodiments, if the raw data 402 indicates that an explicit feature is not present or that an inferred feature cannot be determined or calculated from the raw data 402, the Prediction Engine 206 inserts a “0” in the feature position that corresponds with the missing feature.

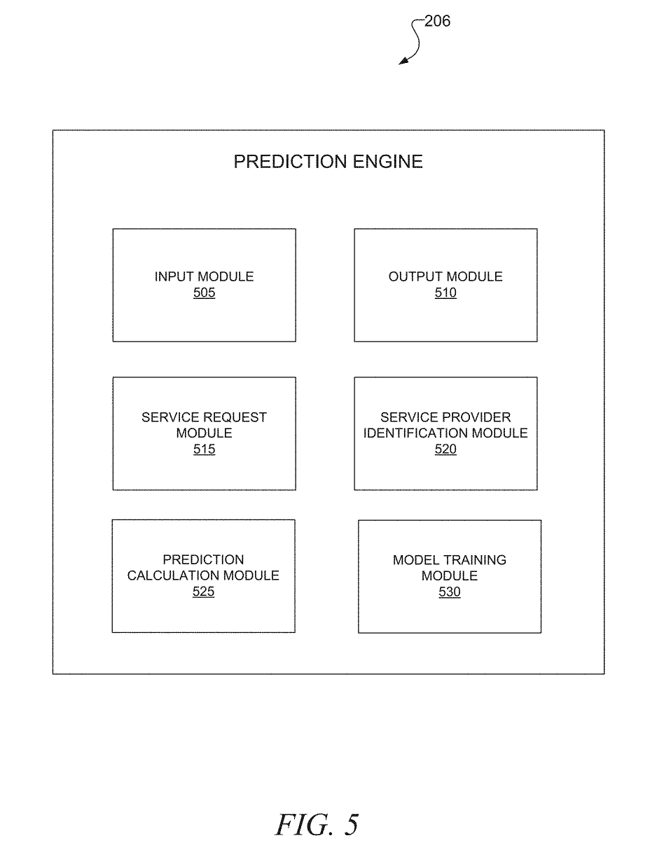

FIG. 5 is a block diagram showing example components of a Prediction Engine 206, according to some embodiments. As shown in FIG. 5. the Prediction Engine 206 includes an input module 505, output module 510, service request module 515, service provider identification module 520, prediction calculation module 525 and a model training module 530.

The input module 505 is a hardware-implemented module that controls, manages and stores information related to any inputs from one or more components of system 102 as illustrated in FIG. 1 and FIG. 2. In various embodiments, the inputs include a requested service from a target consumer account, including any skills and specialties selected by the target consumer account. In addition, inputs include attributes explicitly selected by service provider accounts.

The output module 810 is a hardware-implemented module which sends any outputs to one or more components of system 102 as illustrated in FIG. 1 and FIG. 2. In some embodiments, the output is prediction output that represents a likelihood that a respective service provider account will perform an action related to the requested service. In various embodiments, output can also include a list of service provider accounts ranked according to their corresponding prediction output values. Output can also be a notification sent to a respective service account provider.

The service request module 515 is a hardware implemented module which manages, controls, stores, and accesses information related to receiving a request for a service from a target consumer account. The request can be a request-for-proposals and can include a desired type of service, a desired service provider skills) and desired service provider specialty(s).

The service provider identification module 520 is a hardware-implemented module which manages, controls, stores, and accesses information related to identifying one or more service provider accounts. For example, the service provider identification module 520 identifies service provider accounts that have explicitly selected attributes that match with the target consumer account's service requirements. The explicitly selected attributes are utilized as raw data for explicit features for a feature vector. The service provider identification module 520 identifies service provider accounts that have explicitly selected attributes that match with the target consumer account's service requirements. The service provider identification module 520 further assembles feature vectors for each service provider account based on raw data and feature types of a prediction model.

The prediction calculation module 525 is a hardware-implemented module which manages, controls, stores, and accesses information related to calculating prediction output. For example, the inserts a service provider account's feature vector into the prediction model in order to calculate the prediction output.

The model training module 530 is a hardware-implemented module which manages, controls, stores, and accesses information related to building and updating a prediction model of the Prediction Engine 206. For example, the model training module 530 utilizes logged historical data of various consumer accounts and various target consumer accounts to identifies features for and to train the prediction model. Training the prediction model can occur in an online or offline mode. In addition, the model training module 530 updates the prediction model based on recent requests for services from target consumer accounts, prediction outputs calculated for service provider accounts, ranked lists of service provider accounts, notifications sent to respective service provider accounts and proposals received from service provider accounts.

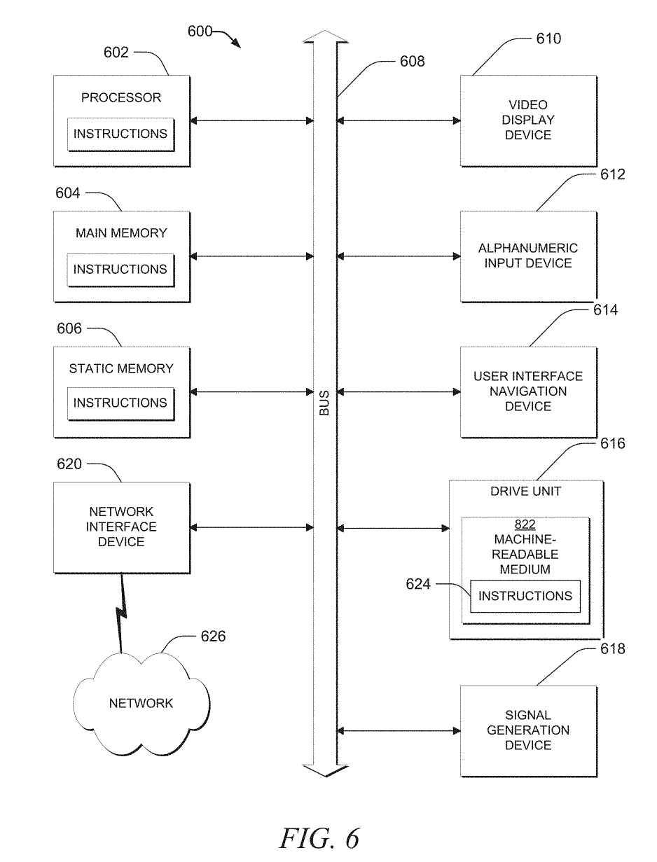

FIG. 6 is a diagrammatic representation of a machine in the example form of a computer system within which a set of instructions, for causing the machine to perform any one or more of the methodologies discussed herein, may be executed.

In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Example computer system 600 includes a processor 602 (e.g., a. central processing unit (CPU), a graphics processing unit (GPU) or both), a main memory 604, and a static memory 606, which communicate with each other via a bus 608. Computer system 600 may further include a video display device 610 (e.g., a liquid crystal display (LCD) or a cathode ray tube (CRT)). Computer system 600 also includes an alphanumeric input device 612 (e.g., a keyboard), a user interface (UI) navigation device 614 (e.g., a mouse or touch sensitive display), a disk drive unit 616, a signal generation device 618 (e.g., a speaker) and a network interface device 620.

Disk drive unit 616 includes a machine-readable medium 622 on which is stored one or more sets of instructions and data structures (e.g., software) 624 embodying or utilized by any one or more of the methodologies or functions described herein. Instructions 624 may also reside, completely or at least partially, within main memory 604, within static memory 606, and/or within processor 602 during execution thereof by computer system 600, main memory 604 and processor 602 also constituting machine-readable media.

While machine-readable medium 622 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present technology, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

Instructions 624 may further be transmitted or received over a communications network 626 using a transmission medium. Instructions 624 may be transmitted using network interface device 620 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMAX networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the technology. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A computer system, comprising:
a processor;
a memory device holding an instruction set executable on the processor to cause the computer system to perform operations comprising:
identifying at least one service provider account in a social network service based in part on request data representative of a request for a service, the request data from a target consumer account in the social network service;
assembling, according to encoded rules of a prediction model, feature vector data for each identified service provider account, wherein each encoded rule of the prediction model comprises at least one pre-defined feature associated with a learned coefficient representing an importance of the respective pre-defined feature; and
generating, based on the feature vector data and the encoded rules of the prediction model, prediction output for each identified service provider account, the prediction output indicative of a likelihood that a respective service provider account will perform an action related to the request for the service.

2. The computer system as in claim 1, wherein identifying a service provider account in a social network service based on request data representative of a request, from a target consumer account in the social network service, for a service comprising:
detecting the request data representative of a request, from a target consumer account in a social network service, for a service;
detecting at least one request data attribute selected by the target consumer account;
identifying at least one service specialty attribute of a respective service provider account, the at least one service specialty attribute selected by the respective service provider account prior to detection of the request data; and
identifying the respective service provider account as qualified for the service based on a match between the at least one request data attribute and the at least one service specialty attribute.

3. The computer system as in claim 2, wherein generating, based on the feature vector data and the encoded rules of the prediction model, prediction output indicative of a likelihood that each service provider account will perform an action related to the requested service comprises:
ranking each identified service provider account Tordin to corresponding prediction output;
selecting, from a pre-defined portion of ranked service provider accounts; and
sending a notification to each selected service provider account, the notification describing the service requested by the target consumer account.

4. The computer system as in claim 1, wherein assembling, according to encoded rules of a prediction model, feature vector data for each service provider account comprises:
accessing encoded data representative of a feature rule for a type of pre-defined feature;
accessing encoded data representative of an attribute of a respective service provider account that corresponds with the type of the pre-defined feature;
identifying a learned coefficient associated with the type of the pre-defined feature; and
assembling, according to the feature rule, a portion of feature vector data for the respective service provider account based on the attribute of the respective service provider service and the learned coefficient associated with the type of the pre-defined feature.

5. The computer system as in claim 4, further comprising:
wherein the feature rule comprises a consumer response feature rule;
wherein accessing encoded data representative of an attribute of a respective service account comprises:
accessing encoded data representative of at least one previous proposal for a service, previously submitted by the respective service provider account, accepted by a second consumer target account;
wherein the learned coefficient is associated with a consumer response feature; and
wherein assembling, according to the feature rule, a portion of feature vector data comprises:
assembling, according to the consumer response feature rule, a portion of feature vector data for the respective service provider account based on the at least one previous proposal for the service and the learned coefficient associated with the consumer response feature.

6. The computer system as in claim 4, further comprises:
wherein the feature rule comprises an availability feature rule;
wherein accessing encoded data representative of an attribute of a respective service account comprises:
accessing encoded data representative of at least one service currently in progress for a second consumer target account by the respective service provider account;
wherein the learned coefficient is associated with an availability feature; and
wherein assembling, according to the feature rule, a portion of feature vector data comprises:
assembling, according to the availability feature rule, a portion of feature vector data for the respective service provide account based on the at least one service currently in progress and the learned coefficient associated with the availability feature.

7. The computer system as in claim 4, further comprises:
wherein the feature rule comprises a social graph rule;
wherein accessing encoded data representative of an attribute of a respective service account comprises:
accessing encoded data representative of at least one common social network connection shared between the consumer target account and the respective service provide account;
wherein the learned coefficient is associated with a social graph feature; and
wherein assembling, according to the feature rule, a portion of feature vector data comprises:
assembling, according to the social graph rule, a portion of feature vector data for the respective service provide account based on the at least one common social network connection and the learned coefficient associated with the social graph feature.

8. The computer system as in claim 4, further comprises:
wherein the feature rule comprises a notifications received rule;
wherein accessing encoded data representative of an attribute of a respective service account comprises:
accessing encoded data representative of an amount of notifications for services, requested by other consumer target accounts, received by the respective service provide account;
wherein the learned coefficient is associated with a notifications received feature; and
wherein assembling, according to the feature rule, a portion of feature vector data comprises:
assembling, according to the notifications received rule, a portion of feature vector data for the respective service provide account based on the amount of notifications for services and the learned coefficient associated with the notifications received feature.

9. A non-transitory computer-readable medium storing executable instructions thereon, which, when executed by a processor, cause the processor to perform operations including:
identifying at least one service provider account in a social network service based in part on request data representative of a request for a service, the request data from a target consumer account in the social network service;
assembling, according to encoded rules of a prediction model, feature vector data for each identified service provider account, wherein each encoded rule of the prediction model comprises at least one pre-defined feature associated with a learned coefficient representing an importance of the respective pre-defined feature; and
generating, based on the feature vector data and the encoded rules of the prediction model, prediction output for each identified service provider account, the prediction output indicative of a likelihood that a respective service provider account will perform an action related to the request for the service.

10. The non-transitory computer-readable medium as in claim 9, wherein identifying a service provider account in a social network service based on request data representative of a request, from a target consumer account in the social network service, for a service comprising:
detecting the request data representative of a request, from a target consumer account in a social network service, for a service;
detecting at least one request data attribute selected by the target consumer account;
identifying at least one service specialty attribute of a respective service provider account, the at least one service specialty attribute selected by the respective service provider account prior to detection of the request data; and
identifying the respective service provider account as a qualified for the service based on a match between the at least one request data attribute and the at least one service specialty attribute.

11. The non-transitory computer-readable medium as in claim 10, wherein generating, based on the feature vector data and the encoded rules of the prediction model, prediction output indicative of a likelihood that each service provider account will perform an action related to the requested service comprises:
ranking each identified service provider account according to corresponding prediction output;
selecting, from a pre-defined portion of ranked service provider accounts; and
sending a notification to each selected service provider account, the notification describing the service requested by the target consumer account.

12. The non-transitory computer-readable medium as in claim 9, wherein assembling, according to encoded rules of a prediction model, feature vector data for each service provider account comprises:
accessing encoded data representative of a feature rule for a type of pre-defined feature;
accessing encoded data representative of an attribute of a respective service provider account that corresponds with the type of the pre-defined feature;
identifying a learned coefficient associated with the type of the pre-defined feature; and
assembling, according to the feature rule, a portion of feature vector data for the respective service provider account based on the attribute of the respective service provider service and the learned coefficient associated with the type of the pre-defined feature.

13. The non-transitory computer-readable medium as in claim 12, further comprising:
wherein the feature rule comprises a consumer response feature rule;
wherein accessing encoded data representative of an attribute of a respective service account comprises:
accessing encoded data representative of at least one previous proposal for a service, previously submitted by the respective service provider account, accepted by a second consumer target account;
wherein the learned coefficient is associated with a consumer response feature; and
wherein assembling, according to the feature rule, a portion of feature vector data comprises:
assembling, according to the consumer response feature rule, a portion of feature vector data for the respective service provide account based on the at least one previous proposal for the service and the learned coefficient associated with the consumer response feature.

14. The non-transitory computer-readable medium as in claim 12, further comprises:
wherein the feature rule comprises an availability feature rule;
wherein accessing encoded data representative of an attribute of a respective service account comprises:
accessing encoded data representative of at least one service currently in progress for a second consumer target account by the respective service provide account wherein the learned coefficient associated with a consumer response feature;
wherein the learned coefficient is associated with an availability feature: and
wherein assembling, according to the feature rule, a portion of feature vector data comprises:
assembling, according to the availability feature rule, a portion of feature vector data for the respective service provide account based on the at least one service currently in progress and the learned coefficient associated with the availability feature.

15. The non-transitory computer-readable medium as in claim 12, further comprises:
wherein the feature rule comprises a social graph rule;
wherein accessing encoded data representative of an attribute of a respective service account comprises:
accessing encoded data representative of at least one common social network connection shared between the consumer target account and the respective service provide account;
wherein the learned coefficient is associated with a social graph feature; and
wherein assembling, according to the feature rule, a portion of feature vector data comprises:
assembling, according to the social graph rule, a portion of feature vector data for the respective service provide account based on the at least one common social network connection and the learned coefficient associated with the social graph feature.

16. The non-transitory computer-readable medium as in claim 12, further comprises:
wherein the feature rule comprises a notifications received rule;
wherein accessing encoded data representative of an attribute of a respective service account comprises:
accessing encoded data representative of an amount of notifications for services, requested by other consumer target accounts, received by the respective service provide account;
wherein the learned coefficient is associated with a notifications received feature; and
wherein assembling, according to the feature rule, a portion of feature vector data comprises:
assembling, according to the notifications received rule, a portion of feature vector data for the respective service provide account based on the amount of notifications for services and the learned coefficient associated with the notifications received feature.

17. A computer-implemented method, comprising:
identifying at least one service provider account in a social network service based in part on request data representative of a request, from a target consumer account in the social network service, for a service;
assembling, according to encoded rules of a prediction model, feature vector data for each identified service provider account, wherein each encoded rule of the prediction model comprises at least one pre-defined feature associated with a learned coefficient representing an importance of the respective pre-defined feature; and
generating, based on the feature vector data and the encoded rules of the prediction model, prediction output for each identified service provider account, the prediction output indicative of a likelihood that a respective service provider account will perform an action related to the request for the service.

18. The computer-implemented method as in claim 17, wherein identifying a service provider account in a social network service based on request data representative of a request, from a target consumer account in the social network service, for a service comprising:
detecting the request data representative of a request, from a target consumer account in a social network service, for a service;
detecting at least one request data attribute selected by the target consumer account;
identifying at least one service specialty attribute of a respective service provider account, the at least one service specialty attribute selected by the respective service provider account prior to detection of the request data; and
identifying the respective service provider account as a qualified for the service based on a match between the at least one request data attribute and the at least one service specialty attribute.

19. The computer-implemented method as in claim 18, wherein generating, based on the feature vector data and the encoded rules of the prediction model, prediction output indicative of a likelihood that each service provider account will perform an action related to the requested service comprises:
ranking each identified service provider account according to corresponding prediction output;
selecting, from a pre-defined portion of ranked service provider accounts; and
sending a notification to each selected service provider account, the notification describing the service requested by the target consumer account.

20. The computer-implemented method as in claim 19, wherein assembling, according to encoded rules of a prediction model, feature vector data for each service provider account comprises:
accessing encoded data representative of a feature rule for a type of pre-defined feature;
accessing encoded data representative of an attribute of a respective service provider account that corresponds with the type of the pre-defined feature;
identifying a learned coefficient associated with the type of the pre-defined feature; and.
assembling, according to the feature rule, a portion of feature vector data for the respective service provider account based on the attribute of the respective service provider service and the learned coefficient associated with the type of the pre-defined feature.
